(19) United States
(12) Patent Application Publication
(10) Pub. No.: US 2018/0320248 A1
(43) Pub. Date: Nov. 8, 2018

(54) SELECTIVE EXTRACTION OF CERIUM FROM OTHER METALS

(71) Applicant: Rare Element Resources Ltd., Littleton, CO (US)

(72) Inventor: Henry Kasaini, Littleton, CO (US)

(21) Appl. No.: 15/937,550

(22) Filed: Mar. 27, 2018

Related U.S. Application Data
(63) Continuation of application No. 14/735,118, filed on Jun. 9, 2015, now abandoned.
Application No. 14/735,118 is a continuation-in-part of application No. 14/158,824, filed on Jan. 18, 2014, now abandoned.
(60) Provisional application No. 62/009,889, filed on Jun. 9, 2014.

(51) Int. Cl. C22B 59/00; C22B 60/02; C22B 3/44

(52) U.S. Cl. CPC C22B 59/00; Y02P 10/234; C22B 3/44; C22B 60/0291

(57) ABSTRACT

Methods for the extraction of cerium and/or thorium from metal compounds and solutions. A single step or two-step extraction method may be applied to selectively precipitate thorium and/or cerium as hydroxides under controlled pH conditions such that a substantially thorium-free and/or cerium-free rare earth element (REE) solution may be formed, such as for the subsequent separation of individual rare earth elements.

### CROSS-REFERENCE TO RELATED APPLICATIONS

This application claims the priority benefit as a continuation application of U.S. patent application Ser. No. 14/735,118 filed on Jun. 9, 2015, which claims the priority benefit as a continuation-in-part of U.S. patent application Ser. No. 14/158,824 filed on Jan. 18, 2014, and which claims the priority benefit under 35 USC § 119(e) of U.S. Provisional Application No. 62/009,889 filed on Jun. 9, 2014. The disclosure of each of these applications is incorporated herein by reference in its entirety. This application is also related to U.S. Provisional Application No. 61/754,420 filed on Jan. 18, 2013, and to U.S. Provisional Application No. 61/902,579 filed Nov. 11, 2013. The disclosure of each of these applications is also incorporated herein by reference in its entirety.

### FIELD

This disclosure relates to the field of extractive metallurgy, particularly for the selective extraction of cerium and/or thorium from feedstocks containing cerium and at least one other rare earth element.

### BACKGROUND

Rare earth elements (REEs) comprise seventeen elements in the periodic table, specifically the 15 lanthanide elements plus scandium and yttrium. REEs are a group of metallic elements with unique chemical, catalytic, magnetic, metallurgical and phosphorescent properties, and as such find use in a wide variety of modern devices including high-strength magnets, batteries, displays, lighting, and high performance metal alloys.

REEs are relatively plentiful in the earth's crust. However, REEs are typically highly dispersed and are not often found as concentrated rare earth minerals in economically exploitable ore deposits. The extraction of REEs from mineral deposits is also challenging because mineral deposits containing REEs typically also contain appreciable levels of radioactive elements such as thorium (Th) and uranium (U) that must be safely and economically separated from the REEs during processing of the ore.

REEs may be further categorized based upon their value and/or their molecular weight. As used herein, the term critical rare earth element (“CREE”) includes neodymium (Nd), europium (Eu), terbium (Tb), dysprosium (Dy), praseodymium (Pr) and yttrium (Y). The term heavy rare earth element (“HREE”) includes terbium (Tb), dysprosium (Dy), holmium (Ho), erbium (Er), thulium (Tm), ytterbium (Yb), lutetium (Lu) and yttrium (Y). The term light rare earth element (“LREE”) refers to lanthanum (La), cerium (Ce), praseodymium (Pr) and neodymium (Nd). Samarium (Sm), europium (Eu) and gadolinium (Gd) are collectively referred to herein as “SEG.”

Among the foregoing, cerium is one of the least valuable REEs. However, cerium is typically found in much higher concentrations than other more valuable REEs, such as the CREEs.

### SUMMARY

As is noted above, cerium is among the least valuable REEs, but typically constitutes a large proportion of the REEs contained in a product derived from an REE-containing mineral ore body. It is an objective of one embodiment disclosed herein to provide a method for rapidly and economically separating cerium from other rare earth elements. Such a method may reduce the complexity and cost of later separating the other REEs, such as the CREEs.

It is an objective of another embodiment disclosed herein to provide a method for the extraction of thorium by precipitating the thorium as thorium hydroxide under controlled pH conditions so that the thorium precipitates without precipitating substantial amounts of rare earth metals. The resulting rare earth solutions are of extremely high purity and may be processed in a solvent extraction circuit for the recovery of high purity rare earth metals, or may be treated to convert the solutions to rare earth oxides. The thorium may be precipitated separately from the cerium, or may be co-precipitated with the cerium.

In one embodiment, a method for the extraction of cerium from a cerium-containing acidic solution is provided. The method includes the steps of contacting the cerium-containing acidic solution with ammonium hydroxide to precipitate at least a portion of the cerium as cerium hydroxide and form a cerium-depleted solution and a cerium hydroxide product, and separating at least a portion of the cerium hydroxide product from the cerium depleted solution.

A number of characterizations, refinements and additional features are applicable to this embodiment. These characterizations, refinements and additional features are applicable to this embodiment of a method for the extraction of cerium individually or in any combination.

In one characterization, the cerium-containing acidic solution is formed by digesting a cerium-containing solid product in an acid. In one refinement, the cerium-containing acidic solution comprises nitric acid. In another characterization, before the step of contacting the cerium-containing acidic solution with ammonium hydroxide, the cerium-containing acidic solution has a free acid content that is sufficient to dissolve a majority of the cerium and to maintain a majority of the cerium as Ce⁴⁺, such as a free acid content that is sufficient to dissolve at least about 95% of the cerium and maintain at least about 95% of the cerium as Ce⁴⁺. In another characterization, before the step of contacting the cerium-containing acidic solution with ammonium hydroxide, the cerium-containing acidic solution has a free acid content of at least about 18%, and in another characterization the cerium-containing acidic solution has a free acid content not greater than about 21%.

In another characterization, the step of contacting the cerium-containing acidic solution with ammonium hydroxide comprises contacting the cerium-containing acidic solution with a sufficient amount of ammonium hydroxide to stabilize a majority of the cerium in the cerium-containing acidic solution as a cerium (IV) ammonium nitrate complex. In another characterization, the step of contacting the cerium-containing acidic solution with ammonium hydroxide comprises contacting the cerium-containing acidic solution with a sufficient amount of ammonium hydroxide to stabilize at least about 95% of the cerium in the liquor as a cerium (IV) ammonium nitrate complex.

In yet another characterization, the step of contacting the cerium-containing acidic solution with ammonium hydroxide comprises contacting the cerium-containing acidic solution with a sufficient amount of ammonium hydroxide to raise the pH of the cerium-containing acidic solution to at least about pH 4.5. In another characterization, the step of contacting the cerium-containing acidic solution with ammonium hydroxide comprises contacting the cerium-containing acidic solution with a sufficient amount of ammonium hydroxide to raise the pH of the cerium-containing acidic solution to not greater than about pH 6.0.

In a further characterization, at least about 60% of the cerium in the cerium-containing acidic solution is precipitated as cerium hydroxide, such as at least about 80% of the cerium in the cerium-containing acidic solution. In certain characterizations, the cerium depleted solution comprises not greater than about 10 wt. % cerium, such as not greater than about 5 wt. % cerium.

In other characterizations, when the cerium-containing acidic solution is formed by digesting a cerium-containing solid product in an acid, the cerium-containing product comprises a compound selected from cerium oxalate and cerium oxide, and in a particular characterization the cerium-containing product comprises cerium oxide (e.g., CeO₂). In one refinement, the method further comprises the step of calcining a cerium-containing oxide precursor at a temperature that is sufficient to convert substantially all of the REEs to RE-oxides and to convert substantially all of the cerium to CeO₂. For example, the calcining may carried out at a temperature of at least about 710° C.

In other characterizations, the cerium-containing product further comprises rare earth elements in addition to cerium. In certain refinements, the cerium-containing product comprises at least two additional rare earth elements in addition to cerium, and may comprise at least three different rare earth elements in addition to cerium. For example, the rare earth elements may include at least three additional rare earth elements selected from the group consisting of dysprosium, europium, terbium, lanthanum, neodymium, praseodymium and yttrium. In another example, the additional rare earth elements include at least one rare earth element selected from the group consisting of neodymium, europium, praseodymium and terbium.

In other characterizations, the cerium hydroxide product comprises not greater than about 10 at. % non-cerium rare earth element compounds, such as not greater than about 4.2 at. % non-cerium rare earth element compounds. In other characterizations, at least about 90 wt. % of the non-cerium rare earth elements in the cerium-containing acidic solution remain solubilized in the cerium depleted solution after the step of contacting the cerium-containing acidic solution with ammonium hydroxide and precipitating cerium, such as at least about 95 at. % of the non-cerium rare earth elements.

In other characterizations, the step of contacting the cerium-containing acidic solution with ammonium hydroxide comprises at least a two-step process of first contacting the cerium-containing acidic solution with a ammonium hydroxide to raise the pH to a first pH to precipitate cerium as cerium hydroxide and form an intermediate cerium depleted solution and a first cerium hydroxide product, and second contacting the intermediate cerium depleted solution with the ammonium hydroxide to raise the pH to a second pH, wherein the second pH is greater than the first pH, to precipitate additional solubilized cerium as cerium hydroxide and form the cerium depleted solution and a second cerium hydroxide product. In one refinement of this characterization, the first pH is at least about pH 3.5, such as at least about pH 4.0. In another refinement, the first pH is not greater than about pH 4.5. In a further refinement, the second pH is at least about pH 5.0, such as at least about pH 5.5. In yet a further refinement the second pH is not greater than about pH 6.0.

In a further refinement, the two-step method further includes the step of separating from the intermediate cerium depleted solution, before the second contacting step, at least a portion of the precipitated cerium hydroxide formed in the first contacting step.

In yet another characterization, the cerium-containing acidic solution further comprises thorium. In one refinement, the concentration of solubilized thorium in the cerium-containing acidic solution is at least about 50 mg/l, and in another refinement is not greater than about 2000 mg/l. In one refinement, the concentration of solubilized thorium in the cerium-containing acidic solution is at least about 100 mg/l, and in another refinement is not greater than about 1600 mg/l. In a further refinement, at least about 95% of the thorium in the cerium-containing acidic solution is co-precipitated with the cerium hydroxide as thorium hydroxide in the cerium hydroxide product. In another refinement, at least about 98% of the thorium in the cerium-containing acidic solution is co-precipitated with the cerium hydroxide as thorium hydroxide in the cerium hydroxide product, such as at least about 99.9% of the thorium. In a further refinement, the cerium depleted solution comprises not greater than about 0.01 at. % thorium, such as not greater than about 0.002 at. % thorium.

In another characterization, the cerium-containing acidic solution further comprises uranium. In yet another characterization, the cerium-containing acidic solution further comprises base metals. In one refinement, substantially all of the base metals remain in the cerium depleted solution.

### DESCRIPTION OF THE DRAWINGS

FIG. 1 is a schematic flowsheet illustrating a method for the selective precipitation of thorium as thorium hydroxide from an acidic solution.

FIG. 2 is a schematic flowsheet illustrating a method for the selective precipitation of thorium as thorium hydroxide from an acidic solution using multiple thorium precipitation steps.

FIG. 3 is a schematic flowsheet illustrating a method for the precipitation of thorium as thorium hydroxide from an acidic solution including the recycle of acid from a solvent extraction circuit.

FIG. 4 is a schematic flowsheet illustrating a method for the precipitation of thorium as thorium hydroxide from an acidic solution including the precipitation of rare earth element hydroxides from a nitric acid solution.

FIG. 5 is a schematic flowsheet illustrating a method for the extraction of cerium as cerium hydroxide from a cerium-containing acidic solution.

FIG. 6 is a schematic flowsheet illustrating a two-stage method for the extraction of cerium as cerium hydroxide from a cerium-containing acidic solution.

FIGS. 7A and 7B illustrate the effect of pH on selective thorium precipitation when using a hydroxide precipitant to precipitate thorium as thorium hydroxide.

FIG. 8 illustrates the selective precipitation of cerium and thorium from a cerium-containing acidic solution in the first stage of a cerium extraction method according to one embodiment.

FIG. 9 illustrates the selective precipitation of cerium and thorium from a cerium depleted solution in the second stage of a cerium extraction method according to one embodiment.

FIG. 10 illustrates the net precipitation of cerium and thorium from a cerium-containing acidic solution in a two-stage cerium extraction method according to one embodiment.

### DESCRIPTION OF THE EMBODIMENTS

In some embodiments, the present disclosure relates to methods for the selective precipitation of thorium (Th) from acidic solutions of metals, such as acidic solutions containing rare earth elements (“REEs”), such as an acidic solution that is derived from a pregnant liquor solution (“PLS”) formed by acid leaching of an ore (e.g., a mineral ore concentrate) containing the REEs. In some embodiments, the present disclosure relates to methods for the selective precipitation of cerium (Ce) from acidic solutions of metals, such as acidic solutions containing REEs, such as a cerium-containing acidic solution that is derived from a PLS formed by acid leaching of an ore (e.g., a mineral ore concentrate) containing the REEs.

In a first embodiment, a method for the selective precipitation of thorium from an acidic solution containing solubilized thorium is provided. The method may be applicable to solutions that contain other solubilized metals in addition to the thorium, such as solubilized REEs, uranium, tantalum or niobium. In one example, the acidic solution includes significant amounts of solubilized REEs (i.e., an acidic REE solution), such as an acidic solution that is derived from a rare earth ore concentrate. In one particular example, the acidic solution includes one or more of yttrium, praseodymium, neodymium, europium, terbium and dysprosium. Although the following description of this embodiment primarily describes the extraction of thorium from such acidic REE solutions, the thorium precipitation method of this embodiment may be applicable to other acidic solutions containing solubilized thorium, such as acidic solutions containing Group 5 metals such as tantalum and/or niobium.

The method of this embodiment includes the precipitation of thorium in the form of thorium hydroxide (e.g., Th(OH)₃ and/or ThO(OH)₃) from an acidic solution. For example, the method may include precipitating thorium as thorium hydroxide by contacting the acidic solution with a hydroxide precipitant, e.g., by contacting the acidic solution with a compound that includes a hydroxide group, such as sodium hydroxide (NaOH) and/or ammonium hydroxide (NH₄OH). Thorium hydroxide may be precipitated from the acidic solution while maintaining a substantial portion of other valuable metals (e.g., REEs) in solution for subsequent recovery of the other metals, such as in a solvent extraction circuit. In one example, the acidic solution may have a relatively low free acid content, such as about 5 g/l (grams per liter) of acid.

Although described primarily with respect to the separation of thorium from solutions containing relatively high concentrations of REEs, the methodology may also be used to separate thorium from solutions having relatively low concentrations of REEs, such as in a scavenger circuit to separate thorium from small but nonetheless valuable quantities of REEs.

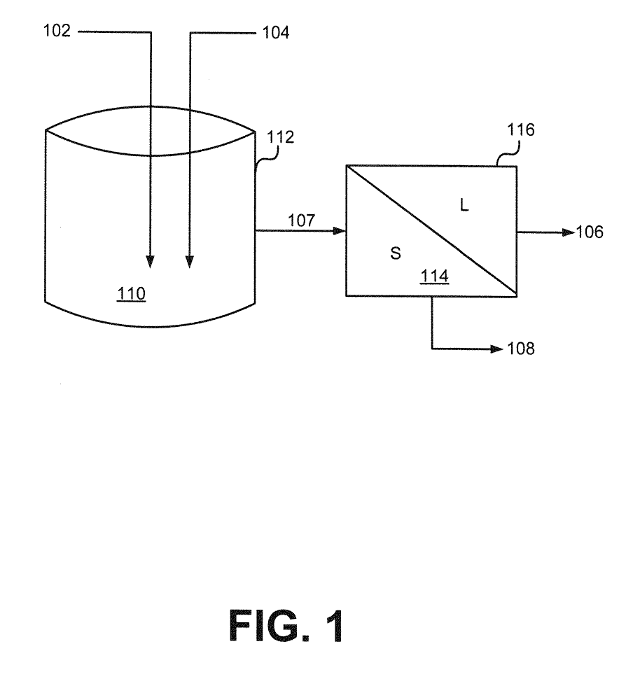

FIG. 1 illustrates a schematic flowsheet of a method for the precipitation of thorium from an acidic solution according to one example of this embodiment. As illustrated in FIG. 1, an acidic solution 102 containing at least solubilized thorium is contacted with a hydroxide precipitant 104 in a hydroxylation (i.e., precipitation) step 110, e.g., by contacting the acidic solution 102 and the hydroxide precipitant 104 in a reactor 112 to cause thorium in the acidic solution 102 to precipitate as thorium hydroxide. After at least a portion of thorium in the acidic solution 102 has precipitated from the acidic solution 102 as thorium hydroxide, a thorium depleted solution 106 may be separated from a thorium hydroxide product 108 in a separating step 114, e.g., using a filter 116.

The acidic solution 102 contains at least solubilized thorium. The acidic solution 102 may be derived from the leaching of a mineral ore (e.g., an ore concentrate) containing REEs or other high-value metals. Thorium is among the elements that are commonly found in mineral deposits containing REEs and the resulting acidic leach solutions typically contain undesirable concentrations of thorium. In one example of this embodiment, the concentration of solubilized thorium in the acidic solution 102 may be at least about 50 mg/l (milligrams per liter), such as at least about 100 mg/l of solubilized thorium in the acidic solution 102, or even at least about 200 mg/l of solubilized thorium. Typically, the acidic solution will comprise not greater than about 1000 mg/l thorium, such as not greater than about 500 mg/l thorium.

The acidic solution 102 may also include one or more REEs, i.e., REEs that are also solubilized in the acidic solution 102. For example, the acidic solution 102 may include REEs in a concentration of at least about 10 grams per liter (WI). In certain characterizations, the acidic solution 102 includes a relatively high concentration of REEs, such as at least about 15 g/l REEs, at least about 20 g/l REEs, at least about 30 g/l or even at least about 50 g/l REEs, where the REEs are solubilized (e.g., dissolved) into the acidic solution 102. Typically, the acidic solution 102 will include not greater than about 100 g/l REEs. In one particular characterization of this example, the acidic solution 102 includes at least one or more REEs of particularly high value, such as one or more of praseodymium, neodymium, europium, terbium and dysprosium.

The solution 102 is acidic and may have a pH of not greater than about pH 4.2, such as not greater than about pH 3.8, prior to being contacted with the hydroxide precipitant 104. In one example, the acidic solution includes nitric acid (HNO₃), although other acids such as sulfuric acid (H₂SO₄) may also be useful in the embodiments disclosed herein. For example, the acidic solution 102 may comprise nitric acid and may be obtained from the acid digestion of rare earth compounds, e.g., the acid digestion of rare earth oxides (RE-oxides), rare earth hydroxides (RE-hydroxides), rare earth oxalates (RE-oxalates) and/or rare earth carbonates (RE-carbonates) with nitric acid to form solubilized nitrate compounds of the REEs. Nitric acid is particularly useful, as the thorium hydroxide precipitated during hydroxylation 110 will become stable and thus will not substantially dissolve, even at a relatively low pH (e.g., at a relatively high acidity).

The acidic solution 102 comprises nitric acid, and in one particular example, the acidic solution 102 has a free acid concentration in the range of from about 0.5 g/l to about 55 g/l HNO₃. When the acidic solution 102 comprises nitric acid, the solubilized elements (e.g., thorium and REEs) may be in the form of solubilized nitrate salts. It is an advantage of this embodiment that the acidic solution 102 may have a relatively low free acid concentration, and therefore may require relatively small quantities of the hydroxide precipitant 104 to precipitate thorium hydroxide and to avoid diluting metal species in solution, which favors crystallization to precipitate thorium.

The acidic solution 102 may also include traces of non-REE elements that are solubilized in the acidic solution 102. For example, the non-REE elements may include metallic elements, such as: alkali metals such as sodium (Na) and potassium (K); alkaline earth metals such as magnesium (Mg), calcium (Ca), strontium (Sr) and barium (Ba); transition metals (e.g., base metals) such as nickel (Ni), copper (Cu), zirconium (Zr), iron (Fe), manganese (Mn) and titanium (Ti); post-transition metals such as lead (Pb) and aluminum (Al); metalloids such as silicon (Si); and other radioactive metals (e.g., actinides) such as uranium (U). The non-REE elements may also include non-metallic elements such as sulfur (S) and phosphorous (P). The acidic solution may also contain other base metals, such as lead (Pb) or zinc (Zn).

In one example, however, the acidic solution 102 includes primarily REEs and thorium, with little or no other non-REE elements (e.g., base metals) that are solubilized in the acidic solution 102. For example, the acidic solution 102 may comprise not greater than about 5 wt. % non-REE elements, such as not greater than about 3 wt. % non-REE elements.

The hydroxylation step 110 includes contacting the thorium-containing acidic solution 102 with a hydroxide precipitant 104, such as sodium hydroxide or ammonium hydroxide, to precipitate a thorium hydroxide product 108 (e.g., predominately containing particulate thorium hydroxide). For example, the reactants may be contacted in a reactor 112 under conditions such that at least a portion of the thorium solubilized in the acidic solution 102 precipitates as a thorium hydroxide product 108.

It is an advantage of the method of this embodiment that the thorium may be precipitated from the acidic solution 102, while a substantial majority of the REEs contained in the acidic solution 102 remain solubilized in a thorium depleted solution 106 that is separated from the thorium hydroxide product 108. To ensure that sufficient quantities of thorium precipitate from the acidic solution 102 and that a substantial majority of REEs in the acidic solution 102 remains solubilized, it has been found that the pH during the hydroxylation step 110 should be maintained at a pH that enables high selectively for thorium, i.e., to preferentially precipitate thorium from the acidic solution 102. In one characterization, the pH during the hydroxylation step 110 is within the range of at least about pH 3 and not greater than about pH 6.0. It has been found that increasing the pH within this range may increase the amount of thorium precipitated from the acidic solution 102 as a thorium hydroxide product 108. In one characterization, the pH during the hydroxylation step 110 is maintained at a pH of at least about pH 3.1, such as at least about pH 3.2, at least about pH 3.3, at least about pH 3.4 or even at least about pH 3.5, such as at least about pH 3.6. However, as the pH approaches higher levels, an increasing quantity of REEs may also precipitate from the acidic solution 102 (e.g., as particulate REE-hydroxides). In the embodiment illustrated in FIG. 1, to avoid the precipitation of undesirable quantities of REEs from the solution, the pH may be maintained at less than about pH 4, such as not greater than pH 3.9 or not greater than pH 3.8. In one example, the pH during the hydroxylation step 110 may be maintained at the desired pH level by controlling the quantity of hydroxide precipitant 104 that is added to the reactor 112 during the hydroxylation step 110, e.g., during the precipitation of thorium from the thorium-containing acidic solution 102.

It has also been found that the desirable range of pH values for the selective precipitation of thorium is dependent upon the concentration of solubilized thorium in the acidic solution 102. In particular, it has been found that increased pH values within the range of about pH 3.5 to pH 4 or slightly higher may be utilized to selectively precipitate thorium as a thorium hydroxide product 108 without precipitating significant amounts of REEs when the concentration of thorium in the acidic solution 102 is relatively low. That is, as the concentration of the thorium in the acidic solution 102 decreases, the pH during the hydroxylation step 110 may be increased to remove additional thorium without removing substantial quantities of REEs. In one example, the acidic solution 102 can be diluted (e.g., with water) to reduce the thorium concentration, and the hydroxylation step 110 may carried out at a higher pH (e.g., pH 3.5 to pH 3.9) without precipitating undesirable quantities of REEs. In one characterization, the acidic solution 102 comprises not greater than about 800 mg/l of thorium, such as not greater than 500 mg/l, or even not greater than about 200 mg/l thorium, and the contacting step is carried out at a pH of at least about pH 3.5, such as at least about pH 3.6, at least about pH 3.7, and even at least about pH 3.8, but typically not greater than pH 4, such a not greater than pH 3.9. However, it is believed that at least about 50 mg/l of thorium is required in the solution for precipitation of thorium to occur.

The thorium-containing acidic solution 102 and the hydroxide precipitant 104 should remain in contact (e.g., in reactor 112) for a period of time sufficient to precipitate a majority (e.g., at least about 50%) of the thorium from the acidic solution 102 and form a thorium depleted solution 106 and a thorium hydroxide product 108. In one characterization, the time of contact (e.g., the average residence time in the reactor) during the hydroxylation step 110 may be at least about 30 minutes and may be not greater than about 90 minutes. It is an advantage of this embodiment that the hydroxylation step 110 may be carried out at ambient temperatures, e.g., the step does not typically require the reactor 112 to be heated or cooled. Further, the hydroxylation step 110 may be carried out at ambient pressures, e.g., the step does not require a sealed or otherwise pressure-controlled reactor 112.

After the contacting step 110, the thorium hydroxide product 108 may be separated from the thorium depleted solution 106 in a separating step 114. For example, a filter 116 may be used to filter the output stream 107 containing thorium hydroxide and the thorium depleted solution 106 from the reactor 112 and retain the thorium hydroxide product 108 on the filter 116. The thorium depleted solution 106 (i.e., the filtrate), containing high levels of REEs and very low levels of thorium, may be further treated as is discussed below to extract cerium. The thorium hydroxide product 108 may advantageously be of high purity, i.e., the product may comprise at least about 99 wt. % thorium hydroxide, such as at least about 99.9 wt. % thorium hydroxide. The thorium hydroxide product 108 may be disposed of, or may be a salable commodity particularly in view of the ability to form a high purity thorium hydroxide product 108.

As is noted above, thorium precipitation from the acidic solution may be enhanced with increased pH (e.g., up to about pH 4) and with a decreased concentration of thorium in the acidic solution and with low free acid content. In one example of this embodiment, this finding may be applied in a multi-step (e.g., two-step) process for the separation of thorium. Specifically, the thorium extraction method of this embodiment may include a first hydroxylation step that includes contacting an acidic solution with a hydroxide precipitant at a first pH, e.g., of at least about pH 3 and not greater than about pH 4, to precipitate a thorium hydroxide product containing very low amounts of REEs and form an intermediate thorium depleted solution, i.e., having a lower concentration of thorium than the acidic solution. The intermediate thorium depleted solution may then be subjected to a second hydroxylation step where the intermediate thorium depleted solution is contacted with a hydroxide precipitant at a second pH of at least about pH 3.1 and not greater than about pH 6, such as not greater than about pH 4.2, where the second pH is greater than the first pH to remove additional thorium. In one particular characterization of this method, the pH during the first hydroxylation step is from about pH 3.0 to about pH 3.3, and the pH during a second hydroxylation step is from about pH 3.5 to about pH 4. In this regard, the pH in the second hydroxylation step may be carried out at such higher pH to aggressively remove thorium, even if some REEs precipitate with the thorium hydroxide product. In the event that some valuable REEs are precipitated with the thorium, the resulting hydroxide product may be recycled, e.g., recycled back to the first hydroxylation step at lower pH.

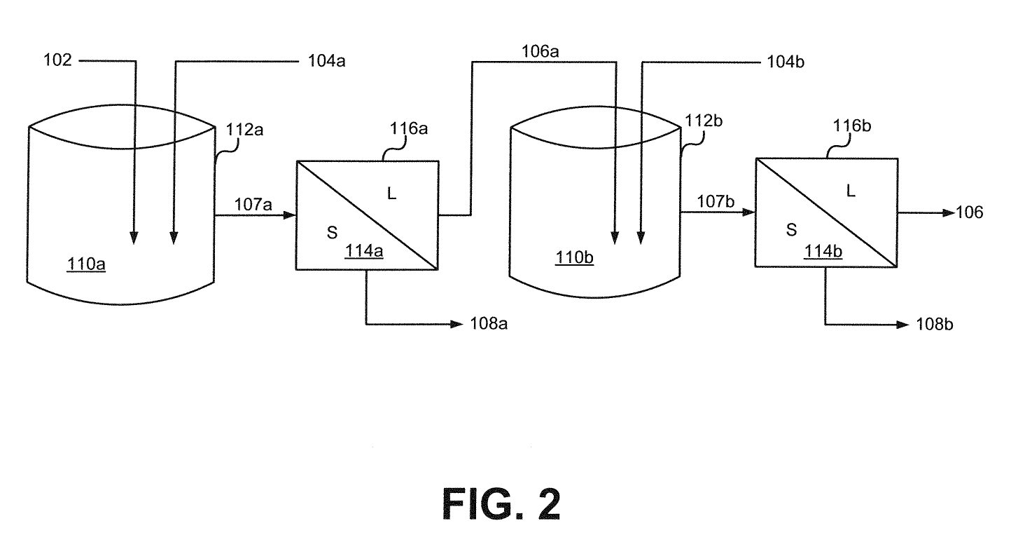

Referring now to FIG. 2, this exemplary method may include a first hydroxylation step 110a where the acidic solution 102 is contacted with a first hydroxide precipitant 104a, such as in a first reactor 112a, under conditions such that at least a portion of the thorium in the acidic solution 102 precipitates as a first thorium hydroxide product 108a and a substantial majority of the REEs (e.g., at least about 99 at. % of the REEs on a metals basis) remain solubilized in an intermediate thorium depleted acidic solution 106a. For example, at least about 50 at. % of the thorium in the acidic solution 102 may be precipitated in reactor 112a and removed in a first separation step 114a, e.g., using a filter 116a. In one particular characterization, at least about 60 at. % and not greater than about 90 at. % of the thorium in the acidic solution 102 is separated from the intermediate thorium depleted solution 106a in the separation step 114a as a thorium hydroxide product 108a. As a result, the intermediate thorium depleted solution 106a recovered from the separation step 114a has a lower concentration of thorium than the acidic solution 102.

As is discussed above, the lower concentration of thorium in the intermediate thorium depleted solution 106a advantageously enables a higher pH to be utilized in a second hydroxylation step 110b (i.e., as compared to the first hydroxylation step 110a), e.g., in a second reactor 112b. Thus, in a second separation step 114b, a second thorium hydroxide product 108b is separated from the thorium depleted solution 106. The thorium depleted solution 106 from the separation step 114b may advantageously include not greater than about 5% of thorium contained in the acidic solution 102, such as not greater than about 2% of the thorium contained in the acidic solution 102. Further, due to the high selectivity of the process, at least about 95%, such as at least about 98%, of REEs in the acidic solution 102 may remain solubilized in the thorium depleted solution 106. Although illustrated as a two-step process in FIG. 2 (e.g., including two hydroxylation steps), the method may include additional incremental steps if desired for enhanced thorium precipitation and/or enhanced REE recovery.

Further, the amount of thorium hydroxide product 108b that is separated to form the thorium depleted solution 106 may be relatively small, as compared to the amount of thorium hydroxide product 108a that is separated to form the intermediate thorium depleted solution 106a. Further, the thorium hydroxide product 108b may include some REEs (due to the higher pH used in hydroxylation step 110b). In one characterization, the thorium hydroxide product 108b may include up to about 20 at. % REEs on a metals basis. Therefore, in one example, the thorium hydroxide product 108b may be recycled back to the first hydroxylation step 110a, so that the recovery of REEs from the thorium depleted solution 106 is increased. That is, any increase in the amount of REEs precipitated as REE-hydroxides in hydroxylation step 110b may be mitigated by recycling the thorium hydroxide product 108b to hydroxylation step 110a, keeping the REEs within the circuit. Thus, in this example, substantially all of the thorium hydroxide may be extracted from the circuit with the thorium hydroxide product 108a while reducing losses of REEs.

In one example of the foregoing embodiments, ammonium hydroxide is utilized as a hydroxide precipitant 104/104a/104b to precipitate thorium as thorium hydroxide. For example, ammonium hydroxide may be added as an aqueous solution having a concentration of from about 10 wt. % to about 20 wt. % ammonium hydroxide, e.g., about 15 wt. % ammonium hydroxide. As a result, the thorium depleted solution 106 recovered from the separation step(s) 114 will contain substantial amounts of ammonium nitrate (NH₄NO₃), dissolved in the thorium depleted solution 106. It may be desirable to continuously or intermittently extract the ammonium nitrate, which is a valuable and salable by-product.

In some examples, it may be advantageous to integrate the method(s) described above for the precipitation of thorium from an acidic solution (e.g., an REE-containing acidic solution) with a solvent extraction circuit for extracting REEs, e.g., from the thorium depleted solution. It may also be advantageous to integrate a method for the formation of the acidic solution, before hydroxylation, by acid digestion of rare earth compounds, such as the acid digestion of RE-oxides. In one particular embodiment, reagent consumption may be reduced and overall operating expenses of the process reduced by recycling nitric acid from a solvent extraction circuit to an acid digestion step to form the above-described acidic solution. In one characterization, nitric acid consumption may be reduced to almost zero, with only make-up nitric acid being added to the process to compensate for normal evaporation and leakage losses.

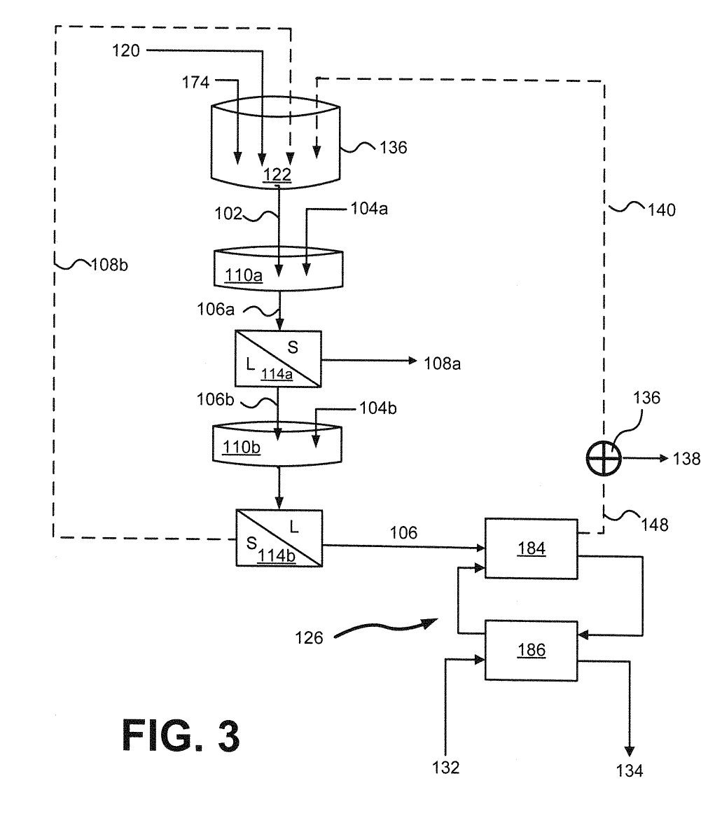

In one example, the acidic solution is formed by the acid digestion of an RE-oxide product, such as one that has a high purity with respect to REEs. As illustrated in FIG. 3, an RE-oxide product 174 may be contacted with an acid 120 (e.g., fresh nitric acid or sulfuric acid) in an acid digestion step 122, such as in a reactor 124. The resulting acidic solution 102 may be an acidic solution substantially as described above with respect to FIGS. 1 and 2. The acidic solution 102 may be contacted in a first hydroxylation step 110a with a hydroxide precipitant 104a to precipitate a thorium hydroxide product 108a from the acidic solution 102. The thorium hydroxide product 108a may be separated from the thorium depleted solution 106b in a separation step 114a. Thereafter, as illustrated with respect to FIG. 2, the intermediate thorium depleted solution 106b may be contacted in a second hydroxylation step 110b with a second hydroxide precipitant 104b to form the thorium depleted solution 106. The thorium depleted solution 106 may then be separated from the second thorium hydroxide product 108b in a separation step 114b.

As is noted above, the amount of thorium hydroxide product 108b may be relatively small and there may be appreciable quantities of REEs in the thorium hydroxide product 108b. To reduce losses of REEs, the thorium hydroxide product 108b may be recycled back to the process, and as illustrated in FIG. 3, the second thorium hydroxide product 108b is recycled back to the acid digestion step 122 where the thorium is re-digested with the RE-oxide product 174. In this manner, all of the thorium hydroxide is removed from the acidic solution 102 with the first thorium hydroxide product 108a. When the thorium hydroxide product 108b is separated in separating step 114b, the resulting thorium depleted solution 106 is a relatively high purity RE-nitrate solution.

The high purity RE-nitrate solution 106 may then be subjected to a solvent extraction circuit 126 to extract REEs from the thorium depleted solution 106. It is an advantage of this embodiment that having the REEs solubilized in nitrate media may reduce the expenses associated with a solvent extraction circuit. The solvent extraction circuit 126 may include the steps of solvent extraction 128 and solvent stripping 130 with a stripping solvent 132. Solvent extraction circuits for the recovery of REEs are known in the art and will not be described here in additional detail. However, because the thorium depleted solution 106 described herein is of extremely high purity, the solvent extraction circuit 126 may advantageously be operated at a reduced capital expense and reduced operating expense. The resulting products are very high purity and high value REEs 134.

As is noted above, the thorium depleted solution 106 may include substantial quantities of highly salable ammonium nitrate. Thus, an ammonium nitrate removal step 136 may be utilized to continuously or intermittently remove ammonium nitrate 138 from the solution 106. As illustrated in FIG. 3, the ammonium nitrate is removed after the solvent extraction circuit 126, as the presence of ammonium nitrate in the thorium depleted solution 106 is not believed to impair the efficacy of the solvent extraction circuit 126. However, it will be appreciated that the ammonium nitrate separation step may also occur before the solvent extraction circuit 126 if desired.

The ammonium nitrate separation step 136 may include cooling the thorium depleted solution to a reduced temperature (e.g., below about 10° C.) to crystallize ammonium nitrate 138. Because ammonium nitrate 138 is highly soluble in acid, it may only be necessary to intermittently operate the separation step 136 to remove ammonium nitrate 138. Ammonium nitrate is valuable and salable by-product that is widely used in the fertilizer industry and may represent a significant source of revenue from the process.

As illustrated in FIG. 3, after separation of the ammonium nitrate 138 (intermittently or continuously), the nitric acid 140 (e.g., recycled nitric acid) may be recycled back to the process, e.g., back to the acid digestion step 122. Thus, the acid (e.g., input at 120) may be contained in an essentially “closed loop” within the process. Additional nitric acid may be generated during the solvent extraction circuit due to cationic ion exchange releasing protons into solution. In this regard, a substantial quantity of the nitric acid required for the acid digestion step may be provided by the recycled nitric acid 140, and only a small amount of fresh nitric acid 120 may be required for the process once steady state and continuous operations are achieved and maintained.

FIG. 3 illustrates the integration of a solvent extraction circuit for the extraction of high purity REEs as metals from the nitrate solution containing the REEs. In other embodiments, it may be advantageous to integrate the method(s) described herein for the precipitation of thorium from an acidic solution with a circuit for precipitating the REEs, e.g., as REE-oxides and/or REE-hydroxides.

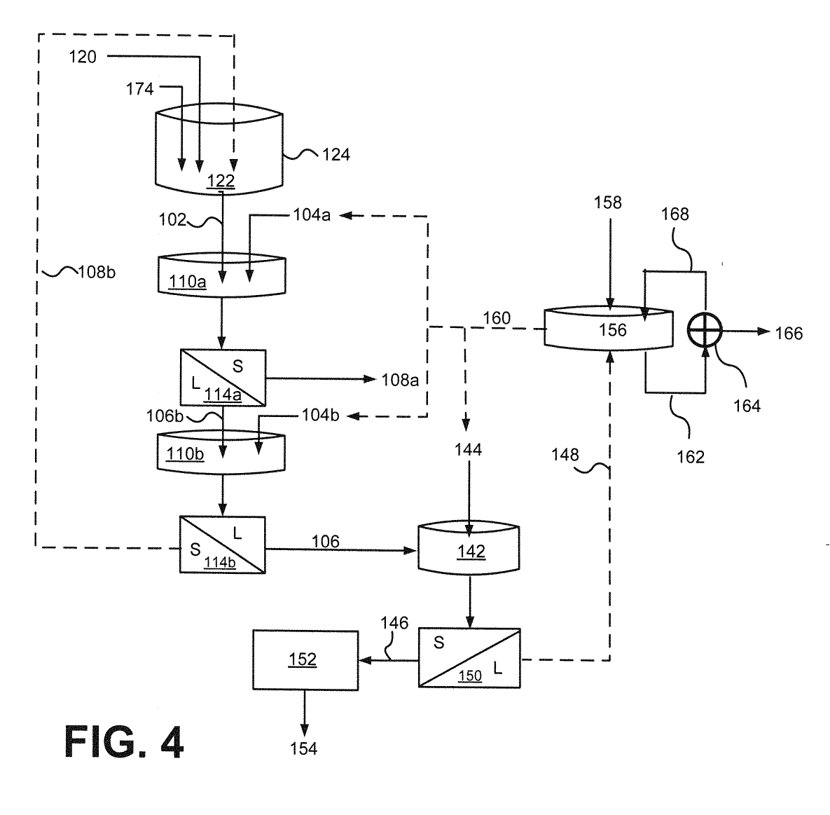

In this regard, FIG. 4 illustrates an example of an integrated process similar to the process illustrated in FIG. 3, but where an REE precipitation circuit replaces the solvent extraction circuit of FIG. 3. Thus, the thorium depleted and REE-nitrate rich solution can be treated to precipitate high purity REE-compounds such as REE-oxides and/or REE-hydroxides which, for example, may be shipped to a separate facility for extraction of the REEs as metals.

Referring to FIG. 4, the thorium depleted solution 106 from the separation step 114b will typically have a pH in the range of about pH 3.6 to about pH 4 (e.g., about pH 3.8) and will be rich in RE-nitrates and may contain no, or extremely low levels of, thorium and/or uranium. For example, the thorium depleted solution 106 may include not greater than about 1 ppm thorium and/or uranium. As illustrated in FIG. 4, this solution 106 is conveyed to an REE precipitation step 142, where the solution 106 is contacted with an REE precipitation agent 144. In one characterization, ammonium hydroxide is used for precipitation in both the precipitation step 144 to precipitate REEs and in the hydroxylation step(s) 110a/110b to precipitate thorium. The REE precipitation agent 144 may be added to the solution 106 in sufficient quantities to increase the pH of the solution, such as by increasing the pH to at least about pH 8, such at least about pH 9. At these pH levels, the REEs will precipitate from the solution 106 as REE-hydroxides 146, which may be separated from an REE-depleted nitrate solution 148 in a separation step 150.

The RE-hydroxides 146 may then be converted from the RE-hydroxides to REE-oxides. As illustrated in FIG. 4, the RE-hydroxides 146 are conveyed to a drying step 152 where the RE-hydroxides are heated to a drying temperature that is sufficient to convert a substantial majority of the RE-hydroxides 146 to RE-oxides 154. For example, the drying step 152 may include heating the RE-hydroxides 146 to a temperature of at least about 100° C., such as at least about 120° C., and not greater than about 160° C., such as not greater than about 150° C. In one example, the REE-hydroxides 146 are conveyed to a screw feed dryer for the substantially continuous production of the RE-oxides 154. In another example, the RE-hydroxides 146 may be stockpiled as necessary and dried.

It is an advantage of this embodiment that the resulting REE oxide product 154 will have a very high purity, particularly with respect to base metals and radioactive metals such as uranium and thorium. In one example, the RE-oxide product 154 has a purity of at least about 99.8% on a metals basis, i.e., the RE-oxide product 154 comprises at least about 99.8% RE-oxides, such as a purity of at least about 99.9%. For example, the RE-oxide product 154 may comprise not greater than about 1 ppm thorium. The uranium content may be not greater than 0.1 ppm, for example, such a not greater than about 0.01 ppm.

An REE-depleted nitrate solution 148 may also recovered from the separation step 158, and may have a high content of ammonium nitrate, such as from about 30 g/l to about 50 g/l ammonium nitrate. The solution 148 may be recycled to preserve nitrates and in particular to preserve ammonium in the process. As illustrated in FIG. 4, the REE-depleted nitrate solution 148 may be conveyed to a vessel 156 where ammonium hydroxide is stored for use in the process, i.e., where the recycled nitrate solution 148 is added to fresh ammonium hydroxide 158. An ammonium hydroxide product 160 such as an ammonium hydroxide solution may then be conveyed as needed to the process, e.g., to hydroxylation steps 110a/110b and/or to REE precipitation step 142. Because the recycled REE-depleted nitrate solution will contain ammonium nitrates, it may be desirable to remove the ammonium nitrates from the ammonium hydroxide vessel 156 on a continuous or intermittent basis. In this regard, a portion 162 of the solution contained within vessel 156 may be periodically bled off from the vessel 156 and subjected to an ammonium nitrate precipitation step 164 to crystallize an ammonium nitrate by-product 166 and recycle an ammonium nitrate depleted solution 168 back to the vessel 156. The ammonium nitrate by-product 166 will be of high purity and a valuable by-product of the process.

While one example for the precipitation of REE compounds from the thorium depleted solution have been described in detail, it will appreciated that other methods may be applied. For example, in some examples, it may be desirable to directly precipitate the REEs as REE-nitrates from the thorium depleted solution.

As is noted above, the thorium-containing acidic solution 102 may contain REEs in addition to thorium, and may be formed by the dissolution of a variety of compounds in an acid (e.g., dissolution by acid digestion). In some of the embodiments disclosed herein, it is desirable that the REEs are in the form of RE-oxalates, e.g., RE₂(C₂O₄)₃ or RE₃(C₂O₄)₃, where RE is a rare earth element. However, the solubility of RE-oxalates in acid is very low. Thus, in one example, the acidic solution 102 is formed by the dissolution of carbonate compounds, such as RE₂(CO)₃.xH₂O where RE is a rare earth element, and Th(CO₃)₂.xH₂O, as illustrated above in FIG. 3. The RE-carbonates may be formed by a variety of methods, and in one example the RE-carbonates are formed from RE-oxalates by a metathesis reaction to render the REEs soluble in an acid such as nitric acid. Methods for the formation of RE-oxalates and RE-carbonates from a mineral ore body containing REEs are described in detail in U.S. Patent Publication No. 2014/0341790 by Kasaini and in PCT Publication No. WO 2014/113742 by Kasaini, each of which is incorporated herein by reference in its entirety.

In such methods, the REE-containing solid product (e.g., a RE-oxalate, RE-carbonate and/or RE-oxide) may have a high purity for REEs on a metals basis (i.e., as compared to non-REE metals in the product). For example, the total non-REE metals (e.g., Ba, Na, K, Si, Sr, Th and/or other base metals) may constitute not greater than about 5 wt. % of the REE-containing solid product on a metals basis, such as not greater than about 3 wt. % or even not greater than 1 wt. % on a metals basis. Table I illustrates the elemental metal concentrations of exemplary REE-containing solid products, i.e., expressed as percentages of the total metal content, as determined by inductively coupled plasma (ICP) analysis.

TABLE I

| | Ex. 1 Concentration | Ex. 2 Concentration |
|---|---|---|
| Element | (at. % of total metals) | (at. % of total metals) |
| REEs | ~98.2 | ~92.5 |
| F | 0.00 | 0.00 |
| Al | <0.01 | <0.01 |
| Ba | 0.44 | 1.00 |
| Ca | 0.16 | <0.10 |
| Fe | 0.16 | 0.58 |
| K | 0.14 | <1.00 |
| Mg | <0.01 | <0.01 |
| Mn | <0.1 | <0.1 |
| Na | 0.08 | <0.1 |
| P | 0.04 | 0.24 |
| Pb | 0.04 | <0.10 |
| S | 0.04 | 0.04 |
| Si | 0.02 | <0.50 |
| Th | 0.52 | 0.58 |
| Ti | 0.02 | <0.10 |
| U | 0.00 | 0.00 |
| Zn | <0.01 | <0.10 |
| Total Non- | ~1.74 | ~7.04 |
| REEs | | |
| Th + U | ~0.52 | ~0.58 |

It is to be understood that the compositions listed in Table I are merely examples and the methods disclosed herein are not limited to the treatment of such REE-containing products.

As is disclosed above, many REE-containing ores include a relatively high concentration of cerium (Ce) as compared to other REEs. For example, in some ore bodies (and hence in the processed ore concentrate) cerium may make up close to 50 wt. % of the total REEs on a metals basis. However, cerium has a lower value than many other REEs and it may be advantageous to separate the cerium from the other REEs, for example to reduce the size of the subsequent solvent extraction circuit and produce an REE-containing end product that has a higher value.

In this regard, one embodiment of the present disclosure is directed to the extraction of cerium from a Ce-containing product. The cerium may be extracted from the Ce-containing product by leaching the Ce-containing product in nitric acid (HNO₃) to dissolve (e.g., solubilize) at least a portion (e.g., at least a majority) of the Ce-containing product to form a cerium-containing acidic solution. The cerium-containing acidic solution may then be contacted with a hydroxide precipitant, e.g. ammonium hydroxide (NH₄OH), to precipitate at least a portion of the cerium as cerium (IV) hydroxide (e.g., Ce(OH)₄) and form a Ce-depleted solution and a Ce-hydroxide product. The cerium-depleted solution, which may contain high levels of valuable non-cerium REEs, may be separated from the Ce-hydroxide product. In some embodiments, the selectivity of the Ce precipitation may be enhanced by the use of a further precipitation step on the Ce-depleted solution step to further reduce the cerium concentration in the Ce-depleted solution.

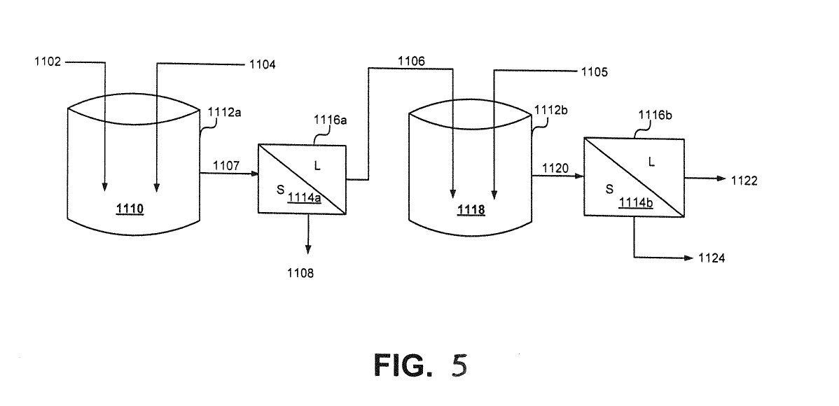

By way of example, FIG. 5 schematically illustrates a method for the extraction of cerium as cerium hydroxide (Ce(OH₄)) from a cerium-containing acidic solution that includes a cerium species. Referring to FIG. 5, a Ce-containing product 1102 is contacted with an acid solution 1104 (e.g., nitric acid) in a leaching step 1110 that may be carried out in a reactor vessel 1112a. The Ce-containing product 1102 may be any product (e.g., a particulate solid product) that contains a cerium compound. The Ce-containing product 1102 may also comprise other REEs whose subsequent recovery is desirable. For example, the Ce-containing product 1102 may be derived from an ore (e.g., from an ore concentrate) that includes cerium and at least one other REE. Often, the Ce-containing product 1102 will comprise other REEs of relatively high value, such as dysprosium, europium, terbium, lanthanum, neodymium, praseodymium and yttrium. The Ce-containing product 1102 may be a product resulting from the processing of an ore concentrate to produce rare earth compounds, such as a rare earth oxide product, a rare earth oxalate product, a rare earth carbonate product, or other rare earth compound(s) that are amenable to dissolution in an acid such as nitric acid. In one particular characterization, the Ce-containing product 1102 comprises RE-oxalates and/or RE-oxides including cerium and non-Ce REEs. According to this embodiment, it is desirable to have the cerium in the Ce-containing product 1102 in the Ce⁴⁺ oxidation state. In one example, at least about 90% of the cerium in the Ce-containing product 1102 is in the Ce⁴⁺ oxidation state, such as where at least about 95% of the cerium, at least about 98% of the cerium, at least about 99% of the cerium or even at least about 99.5% of the cerium is in the Ce⁴⁺ oxidation state. In one particular embodiment, the Ce-containing product 1102 is an RE-oxide product comprising cerium oxide. For example, the RE-oxide product may be formed by calcining (e.g., roasting) a cerium-containing oxide precursor (e.g., RE-carbonates and/or RE-oxalates) at a temperature and under conditions to form RE-oxides and convert a majority (e.g., substantially all) of the cerium to Ce⁴⁺ (e.g., as CeO₂). In one example, RE-oxides are formed by calcining the cerium-containing oxide precursor at a temperature of at least about 700° C., such as at least about 710° C. to convert and/or maintain substantially all of the Ce as Ce⁴⁺.

The Ce-containing product 1102 may or may not comprise thorium. In this regard, the Ce-containing product may have been previously treated to remove thorium, such as by using the methods described above. Alternatively, the thorium may be precipitated before or may be co-precipitated with the cerium.

In one particular characterization, the Ce-containing product 1102 is dispersed in an aqueous composition (e.g., water) to form a pulp (e.g., a slurry) of solid REE compounds (e.g., oxalate and/or an oxide compounds), such as an aqueous pulp comprising at least about 20 wt. % solids and not greater than about 50 wt. % solids. Thus, a solid Ce-containing product (e.g., comprising solid particulate oxalate or oxide compounds) may be mixed with water to form the pulp, for example before leaching with a nitric acid solution 1104.

The nitric acid solution 1104 is contacted with the Ce-containing product 1102 for a period of time sufficient to dissolve (e.g., solubilize) at least a portion of the Ce-containing product 1102, such as for a period of time to dissolve a majority of the Ce-containing product 1102. In one characterization, at least about 95% of the Ce-containing product 1102 is dissolved in the nitric acid solution 1104 during the leaching step 1110. The leaching step 1110 may be carried out at ambient temperature, although elevated temperatures such as in the range of at least about 80° C. and not greater than about 90° C. may be useful. Although slight overpressures may be used if desired, the leaching step 1110 may be carried out at ambient pressure, e.g., of about 1 atm. During the leaching step 1110, it is desirable for the nitric acid solution 1104 to dissolve the Ce-containing product and to maintain a majority of the Ce from the Ce-containing product 1102 in the Ce⁴⁺ oxidation state. To facilitate dissolving and maintaining the Ce in the Ce⁴⁺ oxidation state, the nitric acid solution 1104 may be selected to be of relatively high strength. For example, upon dissolution of the Ce from the Ce-containing product 1102, the strength of the nitric acid solution 1104 should be sufficient to provide a sufficient quantity of protons (H⁺) in the solution 1104 to maintain a majority of the Ce in the Ce⁴⁺ oxidation state, such as at least about 95% of the Ce in the Ce⁴⁺ oxidation state. According to this embodiment, it is desirable to maintain the Ce in the Ce⁴⁺ oxidation state, and although weaker acids may be able to dissolve the Ce-containing product 1102, the dissolved Ce may form in the Ce³⁺ oxidation state if the acid strength is not sufficiently high. For example, the nitric acid solution 1104 may comprise at least about 65 wt. % HNO₃, such as at least about 68 wt. % HNO₃ or even at least about 70 wt. % HNO₃. Characterized another way, at least about 1.9 grams of HNO₃ may be added to the leaching step per gram of solid Ce-containing product (1.9 g HNO₃/g Ce-product). In another characterization, not greater than about 2.4 g HNO₃/g Ce-product may be added to the leaching step 1110. Characterized yet another way, the nitric acid liquor 1106 may have a free acid content of at least about 18% and not greater than about 21% upon completion of the leaching step 1110.

The leaching step 1110 will result in a leach product 1107 comprising solids residue 1108 and a cerium-containing acidic solution 1106 that can be separated from the solids residue 1108 (e.g., undissolved matter) in a separating step 1114a, such as by using a filter 1116a. The solids residue 1108 may be disposed as waste, or may be subjected to further treatment if valuable products (e.g., non-REE metals) are contained in the solids residue 1108.

The cerium-containing acidic solution 1106 is then conveyed to a reactor 1112b where the cerium-containing acidic solution 1106 is contacted with ammonium hydroxide 1105 to precipitate at least a portion of the cerium as cerium hydroxide and form a precipitation stream 1107b comprising a cerium depleted solution 1122 and a cerium hydroxide product 1124.

The precipitation step 1118 (e.g., contacting the cerium-containing acidic solution 1106 with ammonium hydroxide 1105) may advantageously be carried out at ambient temperature and pressure, although elevated temperatures and/or pressures may be employed if desired. As is noted above, the cerium-containing acidic solution 1106 coming into the reactor 1112b may have a relatively high free acid content (e.g., at least about 18% free acid) to maintain the Ce as Ce⁴⁺. As the cerium-containing acidic solution 1106 is contacted with the ammonium hydroxide 1105, the Ce⁴⁺ will begin to form a cerium (IV) ammonium nitrate complex that stabilizes the Ce in the Ce⁴⁺ state. Once the complex forms, and more ammonium hydroxide is added, the pH of the cerium-containing acidic solution 1106 will increase. As the pH increases to about pH 3.5 or higher, the cerium (IV) ammonium nitrate complex will break down and the Ce⁴⁺ will begin to precipitate as cerium (IV) hydroxide, i.e., as Ce(OH)₄ and/or as highly insoluble cerium tetrahydroxide hydrate, i.e., Ce(OH)₄.xH₂O. However, a vast majority of the non-Ce REEs will advantageously remain dissolved in the cerium-containing acidic solution 1106, thereby separating a majority of the cerium from the other REEs.

The ammonium hydroxide 1105 may be added to raise the pH of the cerium-containing acidic solution 1106 in the reactor 1112b to a pH of at least about pH 3.5, such as at least about pH 4.0, at least about pH 4.5, or even at least about pH 5.0. Typically, the pH should not exceed about pH 6.0. In this manner, and in one example, a majority of the cerium originally contained in the cerium-containing acidic solution 1106 may precipitate as Ce-hydroxide. The ammonium hydroxide 1105 may be added as a solution to the cerium-containing acidic solution 1106, e.g., as a solution having a strength of at least about 2.5M. In another characterization, the mass ratio of ammonium hydroxide 1105 to cerium-containing acidic solution 1106 in the reactor 1112b may be at least about 0.065 and may be not greater than about 0.087.

In one characterization, at least about 61% of the cerium originally in the cerium-containing acidic solution 1106 will precipitate as Ce-hydroxide in the Ce-hydroxide precipitation product 1124, such as at least about 70% or even at least about 85%. Further, it is an advantage that the Ce-hydroxide product 1124 comprises relatively low concentrations of non-Ce REEs (e.g., as REE-hydroxides) and that a vast majority of the non-Ce REEs remain solubilized in the Ce-depleted solution 1122. In this regard, the Ce-hydroxide product 1124 may comprise not greater than about 8 at. % of non-Ce REEs on a metals basis, such as not greater than about 4 at. % of non-Ce REEs on a metals basis. In another characterization, at least about 90 at. % of the non-Ce REEs from the cerium-containing acidic solution 1106 may remain solubilized in the Ce-depleted solution 1122, such as at least about 96 at. %. Nonetheless, it may be desirable to recover additional REEs of high value, such as Nd, from the Ce-hydroxide product 1124, such as by subjecting the Ce-hydroxide product 1124 to solvent extraction.

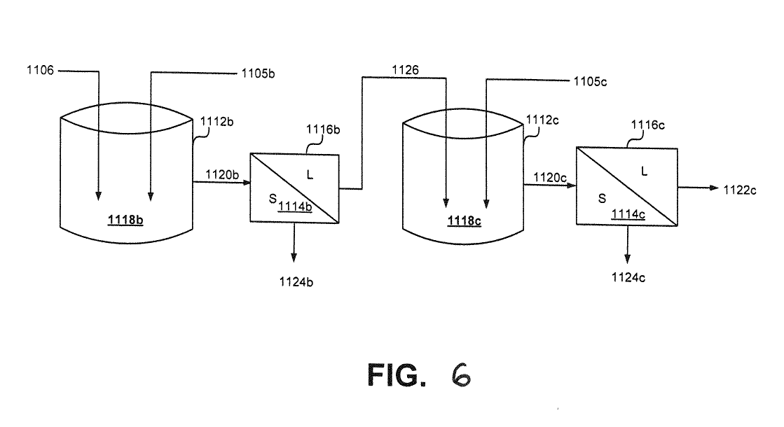

Although a majority of the cerium may be extracted from the Ce-containing product 1102 in the Ce-hydroxide product 1124, it may be desirable to increase the recovery of cerium and form an even purer (i.e., lower cerium concentration) Ce-depleted solution 1122 by conducting a two-step process for cerium precipitation. As is illustrated in FIG. 6, the step of contacting the cerium-containing acidic solution with ammonium hydroxide to precipitate Ce may include first contacting the cerium-containing acidic solution with ammonium hydroxide to raise the pH to a first pH to precipitate cerium as cerium hydroxide and form an intermediate cerium depleted solution and a first cerium hydroxide product, and second contacting the intermediate cerium depleted solution with the ammonium hydroxide to raise the pH to a second pH, wherein the second pH is greater than the first pH, to precipitate additional solubilized cerium as cerium hydroxide and form the cerium depleted solution and a second cerium hydroxide product.

Referring to FIG. 6, such a two-stage precipitation process is schematically illustrated. A cerium-containing acidic solution 1106 comprising dissolved cerium, and possibly appreciable quantities of other REEs, is contacted with ammonium hydroxide 1105b in a reactor 1112b in a first contacting step 1118b. A first precipitation product 1120b is removed from the reactor 1112b and may be subjected to a separation step 1114b, e.g., using a filter 1116b. A Ce-hydroxide product 1124b is separate from an intermediate Ce-depleted solution 1126. The Ce-depleted solution may then be contacted with additional ammonium hydroxide 1105c in a second contacting step 1118c, such as in a second reactor 1112c. After the precipitation of additional cerium from the intermediate Ce-depleted solution 1126, a second precipitation product 1120c may be recovered and separated 1114c into a final Ce-depleted solution 1122c and a second Ce-hydroxide product 1124c.

In accordance with the embodiment illustrated in FIG. 6, the second pH (e.g., in reactor 1116c) is higher than the first pH (e.g., in reactor 1116b). In one example, sufficient ammonium hydroxide 1105b is added to the first reactor 1112b to raise the pH of the cerium-containing acidic solution to at least about pH 3.5, such as at least about pH 4, and not greater than about pH 4.5. In the second precipitation step 1118c, sufficient ammonium hydroxide 1105c is added to the reactor 1118c to further increase the pH of the intermediate cerium-depleted solution to at least about pH 5, such as at least about pH 5.5, and not greater than about pH 6.

As is noted above, the Ce-containing product may also include appreciable amounts of thorium. For example, in some characterizations, the cerium-containing acidic solution may include at least about 50 mg/l thorium, such as at least about 100 mg/l thorium, and not greater than about 2000 mg/l thorium, such as not greater than about 1600 mg/l thorium. In any event, in some embodiments, the precipitation process for the precipitation of Ce may also co-precipitate the thorium such that at least about 98%, at least about 99%, at least about 99.5%, at least about 99.8% or even at least about 99.9% of the thorium in the cerium-containing acidic solution is removed with the Ce-hydroxide product, e.g., as thorium hydroxide. Thus, the cerium depleted solution may comprise not greater than about 0.01 at. % thorium, such as not greater than about 0.002 at. % thorium.

Thus, when the cerium-containing acidic solution comprises thorium, the thorium may precipitate with the cerium (IV) hydroxide as thorium hydroxide. The thorium hydroxide may then be optionally separated from the cerium (IV) hydroxide in the manner noted above (e.g., as illustrated in FIG. 1 and FIG. 2) for the selective precipitation of thorium hydroxide. That is, the cerium-containing product may be redissolved into acid under conditions that a majority of the Ce exists in the Ce³⁺ oxidation state such that cerium will not co-precipitate with the thorium. The Ce and any traces of other REEs will remain in solution.

### EXAMPLES

### Example 1

In the following Example 1, thorium is precipitated from an acidic solution using a hydroxide precipitant at various pH levels to observe the effect of pH on the precipitation of thorium and of REEs.

For these tests, 400 grams (326 ml) of a nitric acid solution having a free acid content of about 5 g/l and a specific gravity of 1.227 is added to a one liter vessel having a mixer. A 1M solution of ammonium hydroxide (NH₄OH) is added dropwise to the vessel until the target pH level is reached, and the target pH is maintained for one hour. A temperature of about 25° C. is maintained during the precipitation step. After 60 minutes, the vessel contents are filtered and the weight, specific gravity and free acid content of the filtrate are measured. The retentate is washed with deionized water and dried. The results are illustrated in Table II.

TABLE II

| | Acidic | | | | | |
|---|---|---|---|---|---|---|
| | Solution | | | | | |
| | Assay | % | % | % | % | % |
| | (mg/l or | Precipitated | Precipitated | Precipitated | Precipitated | Precipitated |
| Element | g/tonne) | @ pH 1.0 | @ pH 2.0 | @ pH 2.5 | @ pH 3.0 | @ pH 3.5 |
| La | 20000 | 7 | 5 | 4 | 0 | 2 |
| Ce | 13500 | 7 | 5 | 3 | 0 | 2 |
| Pr | 3150 | 3 | 0 | 7 | 0 | 19 |
| Nd | 11000 | 4 | 1 | 3 | 0 | 3 |
| Sm | 1580 | 4 | 0 | 8 | 0 | 19 |
| Eu | 352 | 3 | 0 | 7 | 0 | 19 |
| Gd | 814 | 2 | 0 | 5 | 0 | 15 |
| Tb | 62 | 3 | 0 | 8 | 4 | 22 |
| Dy | 204 | 2 | 0 | 5 | 0 | 17 |
| Ho | 24 | 2 | 0 | 4 | 1 | 19 |
| Y | 494 | 5 | 0 | 7 | 0 | 18 |
| Er | 40 | 3 | 0 | 7 | 0 | 15 |
| Tm | 4 | 4 | 4 | 3 | 0 | 18 |
| Yb | 19 | 7 | 6 | 5 | 2 | 21 |
| Lu | 3 | 5 | 5 | 5 | 2 | 21 |
| Sc | <5 | 0 | 0 | 3 | 22 | 70 |
| Th | 734 | 4 | 1 | 8 | 62 | 95 |
| U | 1 | 0 | 0 | 0 | 0 | 24 |

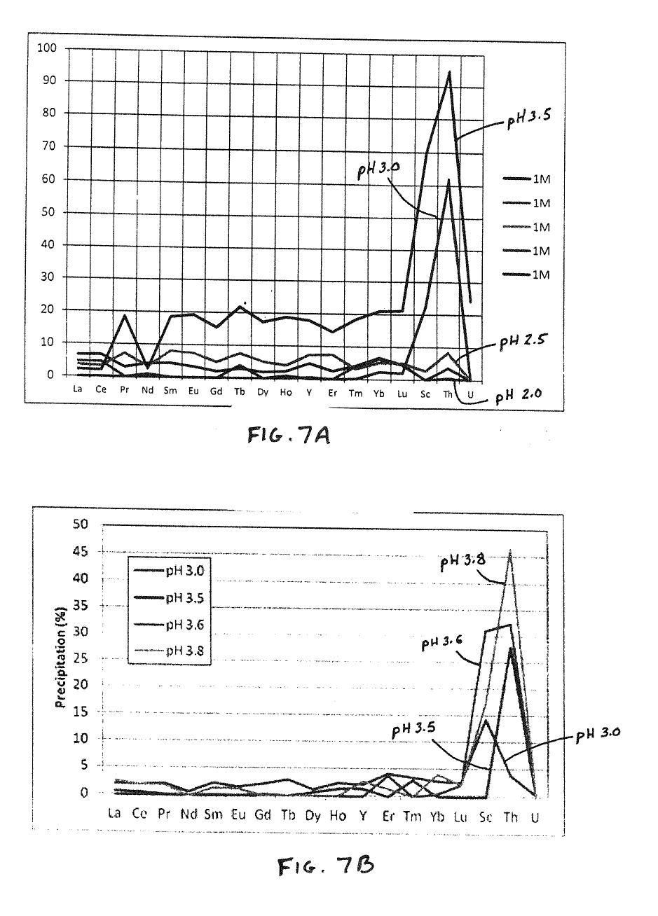

The foregoing data is graphically illustrated in FIG. 7A. This data demonstrates that at pH 3.0, 62% of the thorium in the acidic solution may be precipitated as thorium hydroxide. When the pH is increased to pH 3.5, 95% of thorium is precipitated; however increasing amounts of REEs also begin to precipitate from the solution.

However, if thorium concentration in the solution is decreased, it is found that the pH can be increased without precipitating significant quantities of REEs from the solution. FIG. 7B illustrates the results of increasing the pH of a solution over a range from pH 3.0 to pH 3.8, where the initial thorium concentration is decreased to 117 mg/l. As is illustrated in FIG. 7B, pH levels at least as high as pH 3.8 can be utilized to extract a high percentage of the thorium without precipitating significant amounts of the REEs. The results for the tests at pH 3.5, pH 3.6 and pH 3.8 for a solution containing 117 mg/l thorium are given in Table III.

TABLE III

| | | Final | | Final | | Final | |
|---|---|---|---|---|---|---|---|
| | | Solution | | Solution | | Solution | |
| | | Assay | | Assay | | Assay | |
| | | @ pH | | @ pH | | @ pH | |
| | Feed Assay | 3.5 | Percent | 3.6 | Percent | 3.8 | Percent |
| | (mg/l or | (mg/l or | Removed | (mg/l or | Removed | (mg/l or | Removed |
| Element | g/tonne) | g/tonne) | @ pH 3.5 | g/tonne) | @ pH 3.6 | g/tonne) | @ pH 3.8 |
| La | 2710 | 2200 | 1 | 2220 | 0 | 2160 | 2 |
| Ce | 1870 | 1520 | 1 | 1540 | 0 | 1500 | 2 |
| Pr | 473 | 386 | 0 | 390 | 0 | 380 | 2 |
| Nd | 1630 | 1344 | 0 | 1364 | 0 | 1332 | 0 |
| Sm | 232 | 189 | 0 | 191 | 0 | 187 | 1 |
| Eu | 51.0 | 42 | 0 | 42 | 0 | 41 | 1 |
| Gd | 122 | 99 | 0 | 102 | 0 | 100 | 0 |
| Tb | 9.8 | 8 | 0 | 8 | 0 | 8 | 0 |
| Dy | 30.8 | 23 | 1 | 25 | 0 | 25 | 0 |
| Ho | 3.52 | 5 | 1 | 3 | 0 | 3 | 0 |
| Y | 74.4 | 60 | 1 | 61 | 0 | 59 | 3 |
| Er | 6.15 | 5.06 | 0 | 4.84 | 4 | 4.96 | 1 |
| Tm | 0.58 | 0.46 | 3 | 0.5 | 0 | 0.48 | 0 |
| Yb | 2.83 | 2.32 | 0 | 2.30 | 1 | 2.22 | 4 |
| Lu | 0.35 | 0.30 | 0 | 0.28 | 2 | 0.28 | 2 |
| Sc | 0.71 | 0.62 | 0 | 0.40 | 31 | 0.48 | 17 |
| Th | 117 | 69 | 28 | 65 | 32 | 51 | 46 |
| U | 0.22 | 0.18 | 0 | 0.18 | 0 | 0.18 | 0 |

As is illustrated in this Example 1, high levels of thorium can be extracted from a relatively dilute solution at increased pH levels, without extracting high levels of REEs from the solution.

### Example 2

In this Example 2, the co-precipitation of cerium and thorium from a cerium-containing product is demonstrated. The cerium containing REE-product may contain a very high proportion of lower value cerium as compared to other REEs. In this example, to precipitate cerium, cerium-containing acidic solutions (e.g., nitric acid liquors) containing dissolved cerium and other REEs, as well as thorium, are subjected to a two-step precipitation process where the pH of the two precipitation steps is varied to assess the effect of pH on the selectivity for Ce and Th. The parameters for the first stage precipitation at 3 different pH values are given in Table IV below. In each instance, the cerium-containing acidic solution comprised from about 18% to about 20% HNO₃ and the total contact time was about 1 hour at ambient temperature.

TABLE IV

| | 1^{st} Stage Precipitation | | |
|---|---|---|---|
| Parameter | Example 3A | Example 3B | Example 3C |
| Cerium-containing | 4,210 | 4,710 | 3,720 |
| solution | | | |
| (g) | | | |
| Free HNO₃ | 20.7 | 18.3 | 18.3 |
| (wt. %) | | | |
| NH₄OH Added | 0.080 | 0.065 | 0.087 |
| (g NH₄OH/g solution) | | | |
| 1st stage final pH | 3.7 | 3.3 | 4.0 |
| Precipitated Elements | wt. % | wt. % | wt. % |
| Ce | 60.2 | 61.3 | 62.4 |
| Nd | 4.2 | 6.16 | 3.62 |
| Gd | 5.9 | 7.55 | 5.47 |
| Y | 5.9 | 8.87 | 5.62 |
| Th | 98.5 | 77.1 | 99.9 |

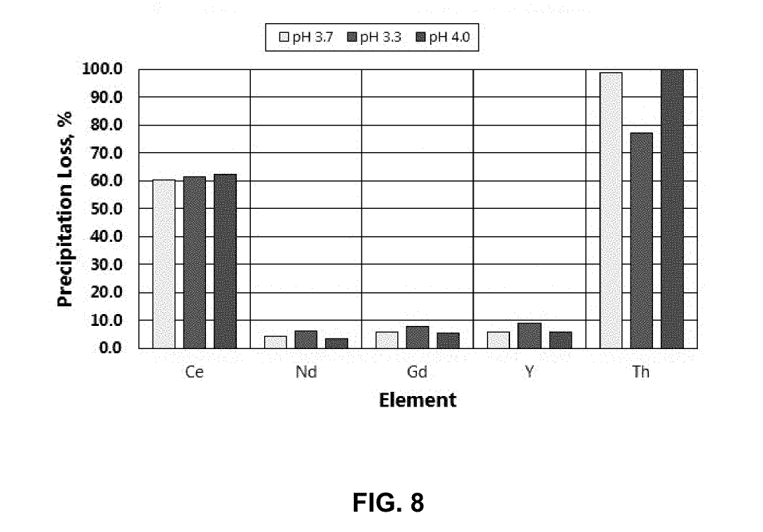

These results are also illustrated in FIG. 8. As illustrated by this data, the precipitation process is highly selective for the precipitation of Ce and Th, to the exclusion of other REEs such as Nd, Gd and Y, particularly at pH values approaching pH 4.

However, the data also illustrates that significant amounts (e.g., about 37% or more) of the cerium remains in the Ce-depleted acidic solution under these conditions. Therefore, a second precipitation step is performed on the Ce-depleted solution from the first precipitation step to extract additional cerium, and possibly thorium, from the first Ce-depleted solution. This second precipitation step is also performed by contacting the (first) Ce-depleted solution with additional ammonium hydroxide to precipitate a (second) portion of Ce from the nitric acid liquor.

Table V illustrates the data for the second stage precipitation.

TABLE V

| | 2nd Stage Precipitation | | |
|---|---|---|---|
| Parameter | Example 3A | Example 3B | Example 3C |
| 1st stage Filtrate | 6620 | 5112 | 6308 |
| (g) | | | |
| Initial pH | 3.7 | 3.3 | 4.0 |
| NH₄OH added | 8 | 46 | 6 |
| 1M-NH₄OH solution | | | |
| (g) | | | |
| Target pH | 4.83 | 4.30 | 5.02 |
| Elements Precipitated | wt. % | wt. % | wt. % |
| Ce | 6.26 | 46.5 | 0.82 |
| Nd | <0 | 1.92 | 0 |
| Gd | <0 | 2.68 | 0 |
| Y | <0 | 2.66 | 0.00 |
| Th | 96.6 | 99.5 | 0 |

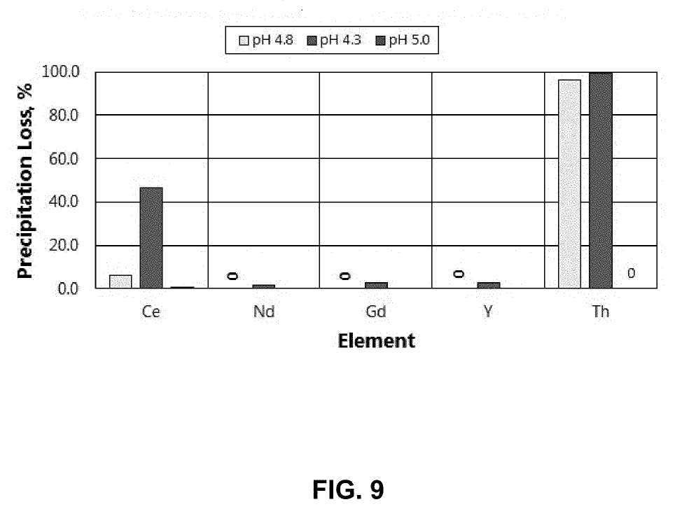

The data for the second precipitation step is also illustrated in FIG. 9. By adjusting the pH of the precipitation steps (e.g., by controlling the addition of NH₄OH), the filtrate (e.g., the cerium depleted solution from the second precipitation step) may be substantially free of cerium and thorium.

Table VI illustrates the combined results of the two-stage precipitation process.

TABLE VI

| | Overall Precipitation | | |
|---|---|---|---|
| Parameter | Example 3A | Example 3B | Example 3C |
| Elements | pH 3.7 & pH 4.8 | pH 3.3 & pH 4.3 | pH 4.0 & pH 5.0 |
| Precipitated | wt. % | wt. % | wt. % |
| Ce | 63 | 80.0 | 63 |
| Nd | 4.18 | 7.96 | 5.47 |
| Gd | 8.38 | 9.48 | 5.37 |
| Y | 8.38 | 9.73 | 5.62 |
| Th | 99.95 | 99.89 | 99.91 |

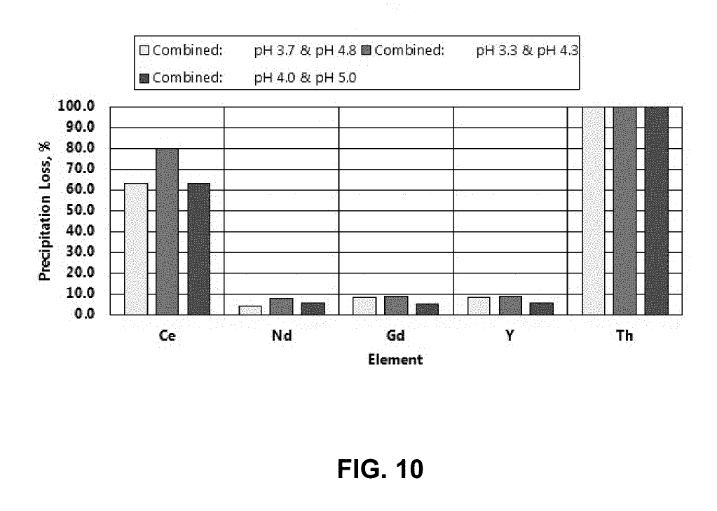

This data is also graphically illustrated in FIG. 10. It can be seen that the two-stage process may result in the removal of one filtrate (solution) that is 80% cerium free and essentially 100% thorium free. A majority of the Ce and essentially all of the Th report to the solid residue.

While various embodiments have been described in detail, it is apparent that modifications and adaptations of those embodiments will occur to those skilled in the art. However, is to be expressly understood that such modifications and adaptations are within the spirit and scope of the present disclosure.

1. A method for the extraction of cerium from a cerium-containing acidic solution, comprising the steps of:
contacting the cerium-containing acidic solution with ammonium hydroxide to precipitate at least a portion of the cerium as cerium hydroxide and form a cerium-depleted solution and a cerium hydroxide product; and
separating at least a portion of the cerium hydroxide product from the cerium depleted solution.

2. The method recited in claim 1, wherein the cerium-containing acidic solution is formed by digesting a cerium-containing solid product in an acid.

3. The method recited in claim 1, wherein the cerium-containing acidic solution comprises nitric acid.

4. The method recited in claim 1, wherein, before the step of contacting the cerium-containing acidic solution with ammonium hydroxide, the cerium-containing acidic solution has a free acid content that is sufficient to dissolve a majority of the cerium and to maintain a majority of the cerium as Ce⁴⁺.

5. The method recited in claim 1, wherein, before the step of contacting the cerium-containing acidic solution with ammonium hydroxide, the cerium-containing acidic solution has a free acid content that is sufficient to dissolve at least about 95% of the cerium and maintain at least about 95% of the cerium as Ce⁴⁺.

6. The method recited in claim 1, wherein, before the step of contacting the cerium-containing acidic solution with ammonium hydroxide, the cerium-containing acidic solution has a free acid content of at least about 18%.

7. The method recited in claim 1, wherein, before the step of contacting the cerium-containing acidic solution with ammonium hydroxide, the cerium-containing acidic solution has a free acid content not greater than about 21%.

8. The method recited in claim 1, wherein the step of contacting the cerium-containing acidic solution with ammonium hydroxide comprises contacting the cerium-containing acidic solution with a sufficient amount of ammonium hydroxide to stabilize a majority of the cerium in the cerium-containing acidic solution as a cerium (IV) ammonium nitrate complex.

9. The method recited in claim 1, wherein the step of contacting the cerium-containing acidic solution with ammonium hydroxide comprises contacting the cerium-containing acidic solution with a sufficient amount of ammonium hydroxide to stabilize at least about 95% of the cerium in the liquor as a cerium (IV) ammonium nitrate complex.

10. The method recited in claim 8, wherein the step of contacting the cerium-containing acidic solution with ammonium hydroxide comprises contacting the cerium-containing acidic solution with a sufficient amount of ammonium hydroxide to raise the pH of the cerium-containing acidic solution to at least about pH 4.5.

11. The method recited in claim 8, wherein the step of contacting the cerium-containing acidic solution with ammonium hydroxide comprises contacting the cerium-containing acidic solution with a sufficient amount of ammonium hydroxide to raise the pH of the cerium-containing acidic solution to not greater than about pH 6.0.

12. The method recited in claim 1, wherein at least about 60% of the cerium in the cerium-containing acidic solution is precipitated as cerium hydroxide.

13. The method recited in claim 1, wherein at least about 80% of the cerium in the cerium-containing acidic solution is precipitated as cerium hydroxide.

14. The method recited in claim 1, wherein the cerium depleted solution comprises not greater than about 10 wt. % cerium.

15. The method recited in claim 1, wherein the cerium depleted solution comprises not greater than about 5 wt. % cerium.

16. The method recited in claim 1, wherein the cerium-containing product comprises a compound selected from cerium oxalate and cerium oxide.

17. The method recited in claim 2, wherein the cerium-containing product comprises cerium oxide.

18. The method recited in claim 17, wherein the method further comprises the step of:
calcining a cerium-containing oxide precursor at a temperature that is sufficient to convert substantially all of the REEs to RE-oxides and to convert substantially all of the cerium to CeO₂.

19. The method recited in claim 18, wherein the calcining is carried out at a temperature of at least about 710° C.

20-47. (canceled)

48. A method for the extraction of thorium from an acidic solution containing solubilized thorium, the method comprising the steps of:
contacting the acidic solution with a hydroxide precipitant at a pH of at least about pH 3 and not greater than about pH 4 to precipitate at least a portion of the thorium as thorium hydroxide and form a thorium depleted solution and a thorium hydroxide product; and
separating at least a portion of the thorium hydroxide product from the thorium depleted solution.
